(19) United States
(12) Patent Application Publication
(10) Pub. No.: US 2023/0006880 A1
(43) Pub. Date: Jan. 5, 2023

(54) LOCAL EDGE AUTHORITY PLATFORM

(71) Applicant: Microsoft Technology Licensing, LLC, Redmond, WA (US)

(72) Inventors: Peter J. KAUFMAN, Sammamish, WA (US); Feng YUE, Redmond, WA (US); Shayak LAHIRI, Redmond, WA (US); Sarah Eleni COOLEY, Seattle, WA (US); Shrivaths Rajagopalan IYENGAR, Redmond, WA (US); Matthew Wayman REYNOLDS, Maple Valley, WA (US); Anshul AGRAWAL, Seattle, WA (US); Joannier Pinales HEVIA, Kirkland, WA (US); Nathan Jeffrey IDE, Bothell, WA (US); Peter John RICHARDS, Snoqualmie, WA (US); Jeffrey Scott PINKSTON, Draper, UT (US)

(21) Appl. No.: 17/364,729

(22) Filed: Jun. 30, 2021

(51) Int. Cl. H04L 12/24; H04L 29/06

(52) U.S. Cl. CPC H04L 41/0816; H04L 63/205

(57) ABSTRACT

Systems and methods providing a local edge authority platform that enables localized control of managed devices with selective cloud and occasional cloud connectivity are provided. The method includes receiving first configuration instructions from a first configuration authority for configuring a managed device; receiving second configuration instructions from a second configuration authority for configuring the managed device, wherein the first configuration authority is different than the second configuration authority; determining a conflict exists between the first configuration instructions and the second configuration instructions; resolving the conflict; and configuring the managed device based on the resolved conflict.

### BACKGROUND

Within organizations throughout the world, a common need for Information Technology (IT) administrators is the convenient ability to manage multiple types of devices and networks across an organization. Accordingly, enterprises are increasingly adopting the cloud to manage devices, especially mobile and desktop devices, where the benefits of the cloud resonate clearly, such as scalability, flexibility, cost reduction, etc. The simplicity of device management via the cloud is appealing to enterprises, particularly because of the opportunities to re-evaluate and rethink existing device management solutions, especially solutions that are home grown and resource drains. However, cloud-based solutions generally require IT intervention for commands and configuration, which is not always available for systems and devices that require local control and cannot, or will not, be constantly connected to the cloud.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and implementations disclosed herein are directed to systems and methods that provide a local edge authority platform that enables localized control of managed devices with selective cloud and occasional cloud connectivity. The method includes receiving first configuration instructions from a first configuration authority for configuring a managed device; receiving second configuration instructions from a second configuration authority for configuring the managed device, wherein the first configuration authority is different than the second configuration authority; determining a conflict exists between the first configuration instructions and the second configuration instructions; resolving the conflict; and configuring the managed device based on the resolved conflict.

### BRIEF DESCRIPTION OF THE DRAWINGS

The present description will be better understood from the following detailed description read in light of the accompanying drawings, wherein:

FIG. 1 is a block diagram illustrating an example computing device for implementing various examples of the present disclosure;

FIG. 2 is a block diagram illustrating an example system including the local edge authority platform according to various examples of the present disclosure;

FIG. 3 is a block diagram illustrating an example system implementing the local edge authority platform according to various examples of the present disclosure;

FIG. 4 is a block diagram illustrating an example system including edge web services and a datastore according to various examples of the present disclosure;

FIG. 5 is a block diagram illustrating an example system including a multi-authority hub according to various examples of the present disclosure;

FIG. 6 is a block diagram illustrating an example system including a configuration filter hub according to various examples of the present disclosure;

FIG. 7 is a block diagram illustrating an example system implementing the local edge authority platform according to various examples of the present disclosure;

FIG. 8 is a flow chart diagram illustrating operations of a computer-implemented method for configuring a managed device according to various examples of the present disclosure;

FIG. 9 is a flow chart diagram illustrating operations of a computer-implemented method for resolving a conflict between configuration instructions according to various examples of the present disclosure; and

FIG. 10 is a block diagram illustrating an example cloud infrastructure according to various examples of the present disclosure.

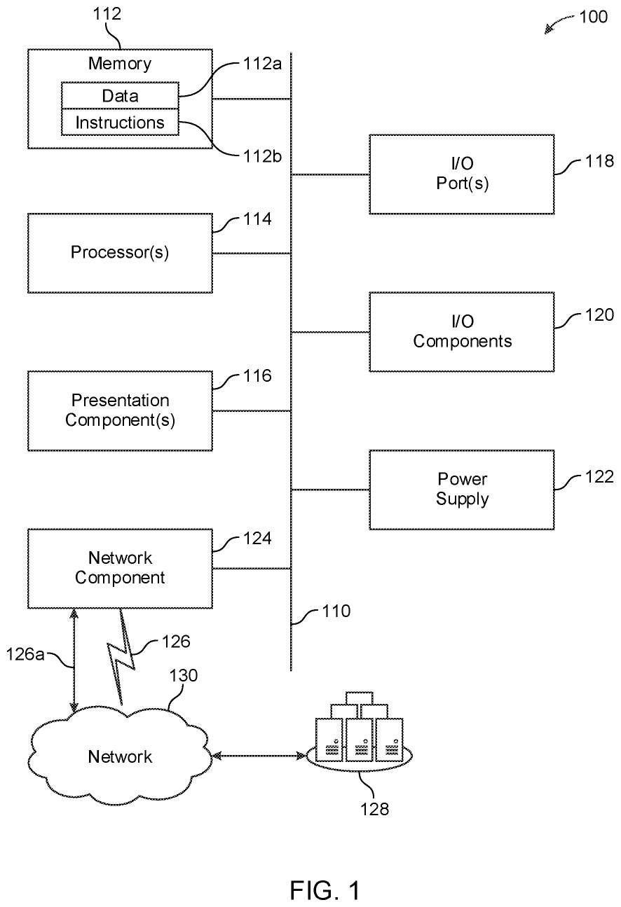

Corresponding reference characters indicate corresponding parts throughout the drawings. In FIGS. 1 to 10, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

In an organization, IT administrators are typically tasked with deploying devices throughout the organization and for ensuring that such devices are adequately configured with various settings that can ensure that the organization's network remains secure and stable. For example, an organization may require that any devices issued to employees of the organization be locked down such that the employees cannot install new applications or modify settings of the device. Alternatively, the organization may restrict installation of applications to the managed device, such that a user can only install certain trusted applications. However, the wide variety of devices that may be deployed by an organization can make management of these devices difficult, as each device may require different configuration values to ensure adherence to the organization's security requirements.

This scenario is made more complex as the cloud is integrated into an enterprise's device management infrastructure. In these scenarios, the enterprise ideally has clear, concise guidance from the cloud provider concerning the local, on-premises needs. The enterprise receives guidance on how to securely lockdown and protect devices from mobile device management (MDM), in addition to potential other needs. The IT department of an enterprise can spend a great amount of time understanding these needs and working out a logistical solution to them. Many of these needs are solved by having local or on-premises control points or authorities for specialization. However, these local edge authorities are sometimes not an integral part of the cloud solution and can therefore potentially become their own isolated environments, in effect becoming what the enterprise intended to avoid by adopting the cloud environment.

Furthermore, due to the time, security, and bandwidth requirements of IT administration, as well as the functional requirements of cloud connectivity, it is also understood that some functions are preferably executed without IT administration oversight. For example, in some implementations, cloud connectivity is not preferred due to security concerns. In addition, due to the various authorities that are used to configure a single device, such as the IT administrator and a localized administrator or device, configuration instructions can sometimes be received that conflict with each other. Accordingly, examples of the present disclosure provide a local edge authority, or hub, that enables configuration of a managed device, or devices, based on configuration instructions from multiple authorities that can, in some instances, provide conflicting instructions. The local edge authority platform determines a hierarchy of authorities, resolves the conflict based on the determined hierarchy, and configures the managed device based on the resolved conflict.

In certain instances, IT administrators can utilize an Enterprise Mobility Management (EMM) service, which can provide a set of services and technologies that can assist with provisioning and securing an organization's devices. For example, an organization may deploy multiple devices, and upon powering on of the devices or periodically during the deployment life of the devices, the devices can interact with the EMM to receive necessary configuration data for provisioning. Such configuration data can include, for example, security policies, wireless passwords, required applications, and various administrator tools, among other settings. An EMM can typically provide some flexibility for the configuration of devices, as one organization that utilizes the EMM may have vastly different requirements than a different organization that utilizes the EMM. As such, the local edge authority platform can utilize EMM to assist with defining the various configuration settings to be applied to deployed devices associated with an organization.

As referenced herein, a semi-connected environment is an environment which is configurable to operate when both connected to the cloud and when not connected to the cloud. For example, a semi-connected device includes connectivity options such that regular operations, such as particular applications and operating systems, are executed without connection to a cloud network or device, but selectively and periodically has access to the cloud environment to receives updates, maintenance, and so forth via an intermediary device that is connected to the cloud. Constant cloud connectivity cannot always be guaranteed. Furthermore, even cloud-connected devices benefit from a delegated, simplified level of control within global guardrails.

As further referenced herein, a configuration authority is an authority that is authorized to configure at least a portion, or a part, of a managed device. In some examples, a configuration authority is an IT administrator, an on-premises device, a LEAP hub that is a parent of another LEAP hub, and so forth. However, these examples should not be construed as limiting and various examples are possible without departing from the scope of the present disclosure.

As further referenced herein, a managed device is a device that can be configured by an authorized configuration authority as described herein. In some examples, a managed device is a local device. However, this example should not be construed as limiting and various examples are possible without departing from the scope of the present disclosure. In some examples, a managed device refers to a plurality, i.e., more than one, managed device. In some examples, the managed device can be configured by more than one configuration authority simultaneously. For example, the managed device can include multiple types of configuration data such as security policies, wireless passwords, required applications, and various administrator tools, among other settings, that are configured via multiple configuration authorities.

Current solutions fail to provide sufficient solutions for configuring a managed devices based on multiple configuration instructions that are received from different sources, while meeting requirements for edge devices that operate with low network saturation, are battery conscious, and so forth. Solutions that do attempt to address these challenges fail to sufficiently delegate configurations, fail to provide the security and framework typically provided by an IT administrator, and/or fail to enable to use of a same operating system configuration surface. In particular, the current solutions fail to provide a technical solution that provides a same operating system configuration for different authorities such as an IT administrator and an independent software vendor (ISV), enables third-party control planes on the edge of a semi-connected environment to configure or re-configure either alone or with the cloud, provides a delegated, simplified level of control within global guardrails, and provides a secure agent and device/service communication protocol compatible with particular software requirements.

Various examples of the present disclosure address the above-identified challenges by providing a local edge authority platform that enables localized control of managed devices with selective cloud and occasional cloud connectivity. The local edge authority platform segregates the various authorities that are used to configure the managed devices, filters the configuration instructions according to the authorities, resolves conflicts between the instructions received from the various authorities, and configures the managed devices according to the configuration instructions. Providing a local, i.e., on-site or on-premises, hub platform provides a series of advantages, including not limited to a standard device configuration control plane, extensibility for additional specialized control planes, multi-authority conflict/precedence resolution, device authentication, an authorization/RBAC model, a targeting/specialty model, a local application and update repository with deployment support, cloud disconnect/reconnect handling to a cloud authority, telemetry and diagnostics, investigative tooling, a staging/testing platform, and a break-glass ability to mitigate device-management blocking issues. Furthermore, support for the local authority in a local edge authority platform enables an enterprise on-premises ecosystem to seamlessly integrate with a cloud computing environment.

Aspects of the present disclosure provide a computer-implemented method and system for configuring a managed device in an edge authority platform. The computer-implemented method includes receiving first configuration instructions from a first configuration authority for configuring a managed device; receiving second configuration instructions from a second configuration authority for configuring the managed device, wherein the first configuration authority is different than the second configuration authority; determining a conflict exists between the first configuration instructions and the second configuration instructions; resolving the conflict; and configuring the managed device based on the resolved conflict.

Accordingly, the system provided in the present disclosure operates in an unconventional manner by introducing a security model to managed device configuration that segregates multiple authorities used to configure the managed device, filtering configuration instructions from the multiple authorities, resolving conflicts between the instructions, and configuring the managed device based on the configuration instructions, all while meeting security levels of global guardrails and providing the same operating system configuration for the different authorities.

FIG. 1 is a block diagram illustrating an example computing device 100 for implementing aspects disclosed herein and is designated generally as computing device 100. Computing device 100 is but one example of a suitable computing environment and is not intended to suggest any limitation as to the scope of use or functionality of the examples disclosed herein. Neither should the computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Program components include routines, programs, objects, components, data structures, and the like that refer to code, performs particular tasks, or implement particular abstract data types. The disclosed examples may be practiced in a variety of system configurations, including servers, personal computers, laptops, smart phones, servers, VMs, mobile tablets, hand-held devices, consumer electronics, specialty computing devices, etc. The disclosed examples may also be practiced in distributed computing environments when tasks are performed by remote-processing devices that are linked through a communications network.

The computing device 100 includes a bus 110 that directly or indirectly couples the following devices: computer-storage memory 112, one or more processors 114, one or more presentation components 116, I/O ports 118, I/O components 120, a power supply 122, and a network component 124. While the computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an operating system (OS), a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100, including, for example but without limitation: WINDOWS® developed by the MICROSOFT CORPORATION®, MAC OS® developed by APPLE, INC.® of Cupertino, Calif., ANDROID™ developed by GOOGLE, INC.® of Mountain View, Calif., open-source LINUX®, and the like.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor 114, by multiple processors 114 within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Example presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

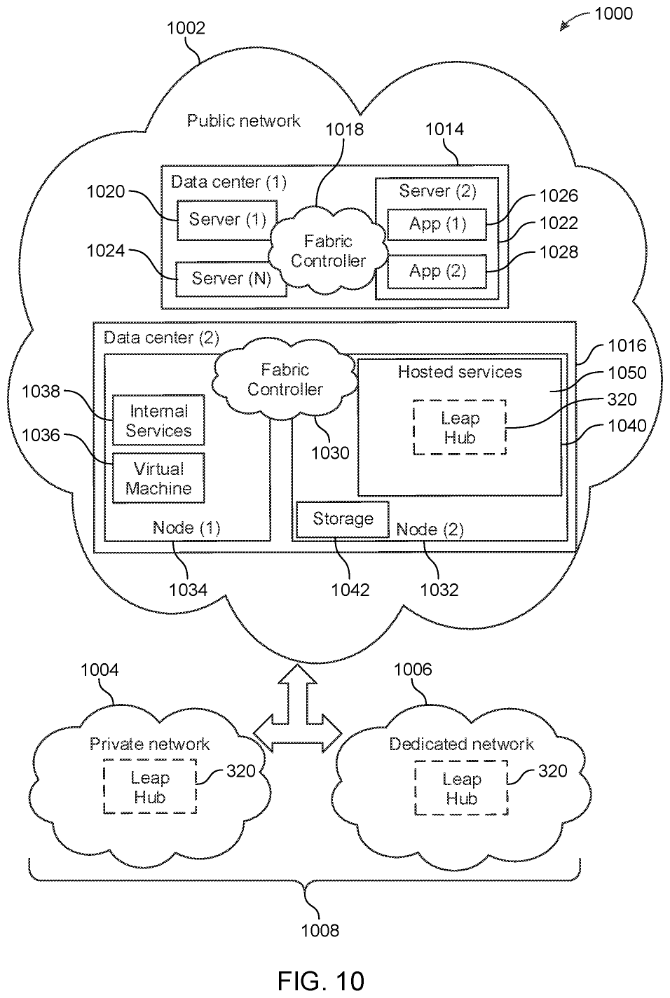

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128, such as the cloud computing environment illustrated in FIG. 10. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN); metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

As described herein, the computing device 100 can be implemented as one or more servers. The computing device 100 can be implemented as a local edge authority platform, or hub, such as the platform management server 202, the LEAP hub 320, the LEAP hub 330, the LEAP hub 520, the LEAP hub 620, and/or the LEAP hub 720.

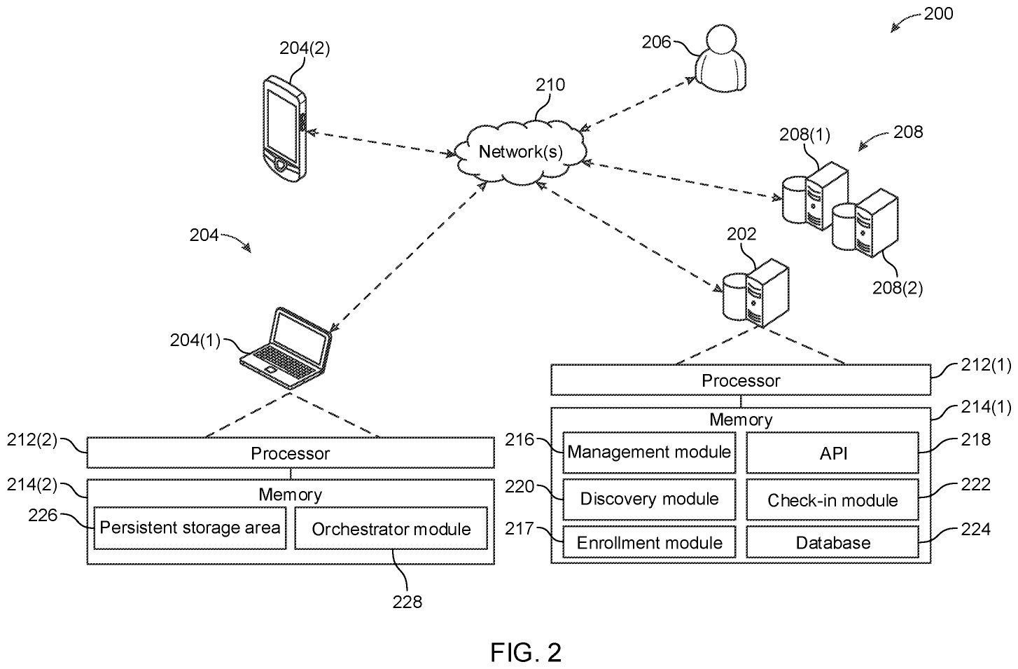

FIG. 2 is a block diagram illustrating an example system including the local edge authority platform (LEAP) according to various examples of the present disclosure. As depicted in FIG. 2, the system 200 comprises a platform management server 202 that can be utilized to manage the provisioning of one or more managed device(s) 204, which may include desktop or laptop devices 204(1) or portable devices 204(2), for example. In some examples, the platform management server 202 is the computing device 100. For example, the processor 212(1) can be the processor 114 and the memory 214(1) can be the memory 112. The management of managed devices 204 may be initiated by an administrator 206, who may interact with one or more enterprise service(s) 208 to define configuration settings to be used for provisioning managed devices 204 and can monitor the status of the provisioning process. Enterprise services 208 may be an EMM, and may include multiple different types of EMMs, such as EMM 208(1) which may be an EMM provided by a particular service provider, while EMM 208(2) may be an EMM provided by a different service provider.

As described herein, the platform management server 202 provides a local authority hub to various devices enrolled to it. In some examples, the local authority hub is a conduit for local authorities to manage enrolled devices. For example, the system 200 can be a local edge authority platform that implements the local authority hub, such as the platform management server 202, that is the local authority. Multiple simultaneous control planes through the hub to manage multiple devices are supported, with the hub, i.e., the platform management server 202, serving as the scenario controller. Providing a local, i.e., on-site or on-premises, hub platform provides a series of advantages, including not limited to a standard device configuration control plane, extensibility for additional specialized control planes, multi-authority conflict/precedence resolution, device authentication, an authorization/RBAC model, a targeting/specialty model, a local application and update repository with deployment support, cloud disconnect/reconnect handling to a cloud authority, telemetry and diagnostics, investigative tooling, a staging/testing platform, and a break-glass ability to mitigate device-management blocking issues. Furthermore, support for the local authority in a local edge authority platform enables an enterprise on-premises ecosystem to seamlessly integrate with a cloud computing environment.

Platform management server 202, managed devices 204, administrator 206, and enterprise services 208 may all be communicatively coupled by way of a network 210 (e.g., the Internet or an intranet). In some examples, the network 210 is the network 130. However, it is to be appreciated that while the various entities depicted in system 200 can be communicatively coupled to network 210, not all of the entities may necessarily communicate with each other. For example, in some implementations, administrator 206 may only communicate with the platform management server 202 and does not have the direct ability to communicate with enterprise service 208. Similarly, enterprise service 208 may not have the ability to communicate directly with managed devices 204, as platform management server 202 can be in charge of communication with the managed devices 204.

Platform management server 202 and managed devices 204 may each comprise a processor 212 and memory 214, as illustrated in FIG. 1. Memory 214 may have various software modules that can be executable by processor 212 for performing the processes disclosed herein. Memory 214 can include both persistent storage resources, such as magnetic or solid-state drives, and volatile storage, such as one or more random-access memory devices. In some examples, the modules described herein in connection with memory 214 can be provided as executable instructions that are stored on persistent storage devices, loaded into the random-access memory (RAM), and read from RAM by the processor for execution.

Memory 214(1) associated with platform management server 202 can include or have access to a management module 216, which may be a software program executable by processor 212 for performing the various management tasks associated with configuring managed devices 204. Memory 214(1) may also include an API 218 that can be exposed to provide programming interfaces for use by enterprise service 208, and a discovery module 220 and check-in module 222 that can interact with deployed devices.

In some examples, the memory 214(1) further includes an enrollment module 217. The enrollment module 217 enrolls the managed device 204 into the management module 216 and tracks the managed device 204. In other words, enrolling the managed device 204 into the management module 216 initiates the management protocol executed by the management module 216. The managed device 204 queries the discovery module 220 and the enrollment module 217 is returned to the managed device 204 as well as the check-in module 222 used by the managed device 204 to ping the hub for various policies and/or configurations. The API module 218 takes configuration requests received from an IT Administrator or another authority and stores the requests until the managed device 204 checks in. When the managed device 204 checks in, the management module 216 supplies the configuration data as the response back to the managed device 204.

In one implementation, enterprise service 208 may include a software application usable by administrator 206 that can include a graphical user interface (GUI) for displaying a visual depiction of managed devices 204 within the organization, and present information to administrator 206 about the various options available for configuring the devices by way of configuration settings that can be applied to the devices as provided by platform management server 202. In particular, the GUI of enterprise service 208 may interact with management module 216 by making programmatic calls using API 218 to pull certain information regarding configuration capabilities of management module 216, and to provide received configuration data in a form suitable for processing by management module 216. Such configuration data can be stored, for example, in a database 224 of platform management server 202.

In some implementations, management module 216 may allow only certain configuration data, regardless of the particular EMM that is utilizing platform management server 202 to manage the devices. By only providing API calls for particular types of information, platform management server 202 can ensure that configuration settings applied by administrator 206 via enterprise service 208 do not go outside the bounds of the predefined configuration settings. For example, while the configuration settings utilized by platform management server 202 can include a large listing of various data fields, an EMM would not be able to specify additional secret values beyond the fields in the configuration settings. This can ensure that management module 216 can appropriately precompute a configuration packet for managed devices 204 without running into problems of how to handle unknown data, which could result in system instability.

In providing enterprise service 208 the ability to define configuration data for use by multiple types of managed devices 204, management module 216 may abstract out the details of how the configuration can be applied to each of the managed devices 204, as the management module can ultimately precompute the necessary device-specific configuration steps once the device checks-in, regardless of what kind of device it is. As such, an administrator 206 can provide generic configuration data via platform management server 202 by filling in any relevant data that is specified by the configuration settings without regard to device implementation, along with an assignment of the data to a particular device. The assignment of configuration settings to particular devices can utilize a flexible assignment system that can easily allow administrator 206 to specify certain devices among the organization's various deployed devices.

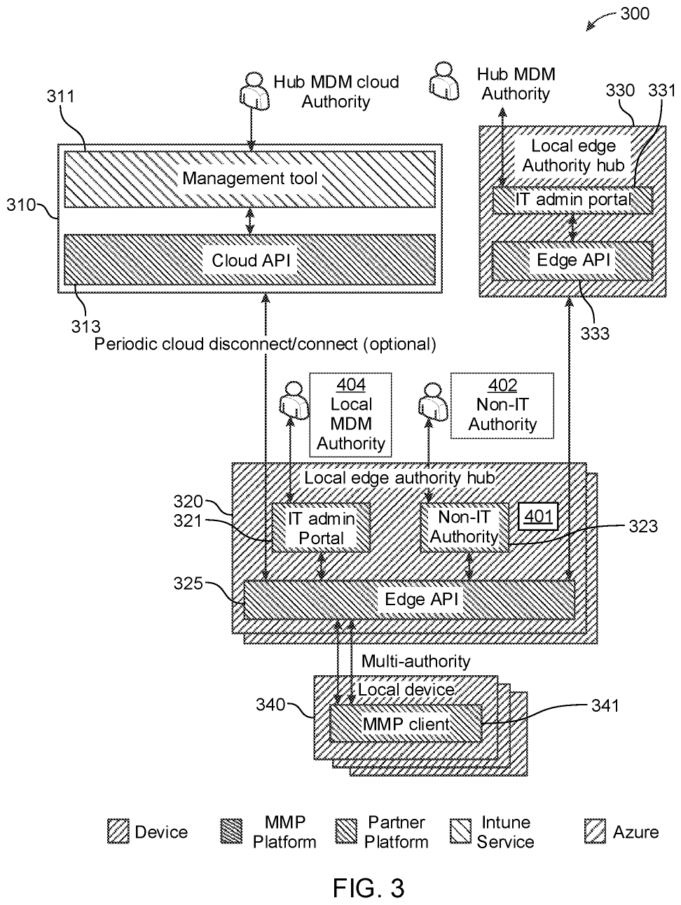

FIG. 3 is a block diagram illustrating an example system implementing the local edge authority platform (LEAP) according to various examples of the present disclosure. The system 300 is but one example of a suitable system and is not intended to suggest any limitation as to the scope of use or functionality of the examples disclosed herein. Neither should the system 300 be interpreted as having any dependency or requirement relating to any one or combination of components/modules illustrated. The system 300 provides an architecture where a device configuration system has encapsulated control and data planes for specialized scenarios that can be applied independently of a cloud computing environment while maintaining its own self-contained identity, targeting, notification, storage, updatability, and segregated capabilities. Further, the device configuration system does maintain a capability to connect to the cloud computing environment selectively and periodically, for example for degrees of centralized authority control, monitoring, and/or remediation.

The system 300 includes a cloud computing device 310. In some examples, the cloud computing device 310 is an IT administrator, or IT administrators, that implements a cloud computing device or devices. In some examples, the cloud computing device 310 is referred to herein as a first configuration authority and/or a hub MDM cloud authority. The cloud computing device 310 includes a management tool 311 and a cloud API 313. In some examples, the cloud API 313 is an EMM API.

The system 300 further includes a local edge authority platform (LEAP) hub 320. In some examples, the LEAP hub 320 is the computing device 101 and/or the platform management server 202. For example, the LEAP hub 320 can be a local server or any other suitable computing device. The LEAP hub 320 includes an IT administrative portal 321 that transmits and receives signals to and from, respectively, a local MDM authority. The LEAP hub 320 further includes a non-IT authority 323 and an edge API 325. The non-IT authority 323 transmits and receives signals to and from, respectively, a local device trainer authority that sends data to train a local device. The edge API 325 transmits and receives signals and data to and from, respectively, the cloud computing device 310, the IT administrative portal 321, and the non-IT authority 323. In particular, the edge API 325 enables different authorities to configure a managed device 204, such as the local device 340, while being simultaneously enrolled with the LEAP hub 320. For example, the edge API 325 enables an IT administrator to manage the device security, a classroom instructor managing to student lessons and test taking, a trainer to train particular devices, a technician to monitor and diagnose device issues, and so forth simultaneously and independently.

In some examples, the LEAP hub 320 is connected to additional authority hubs, in addition to or instead of the LEAP hub 330 and/or the cloud computing device 310, that the LEAP hub 320 has authority to configure or be configured by. In other words, although the LEAP hub 320 is discussed herein as connected to the cloud computing device 310 and the LEAP hub 320, various examples are possible. For example, policies can be implemented in the LEAP hub 320 can be received from another cloud authority, another LEAP hub, and so forth.

The system 300 further includes at least one local devices 340. In some examples, the at least one local device 340 is the managed device 204. Although illustrated in FIG. 3 as including one local device 340, the local device 340 is illustrated for simplicity only. The system 300 can include any number of local devices 340 without departing from the scope of the present disclosure. The local device 340 includes a MMP client 341. The local device 340 is enrolled to the system 300 and has a clearly segregated privilege surface area to enable the segregated configuration as described herein.

In some examples, the system 300 further includes a second LEAP hub 330. The second LEAP hub 330 includes an IT administrative portal 331, an edge API 333, and an enrollment module 401. In some examples, the LEAP hub 330 is referred to herein as a second configuration authority. The second LEAP hub 330 is an additional authority for configuring the local device 340. In some examples, the various authorities for configuring the local device 340 can have precedence ranking for configuring the local device 340. As described in greater detail below, in examples where the instructions for configuration of the local device 340 conflict, the authority with the higher precedence ranking takes precedence. In examples where the authorities have the same rank, the most secure setting takes place, if possible. In examples where the most secure setting is not available or cannot be returned, an error is returned and the local device 340 is not configured.

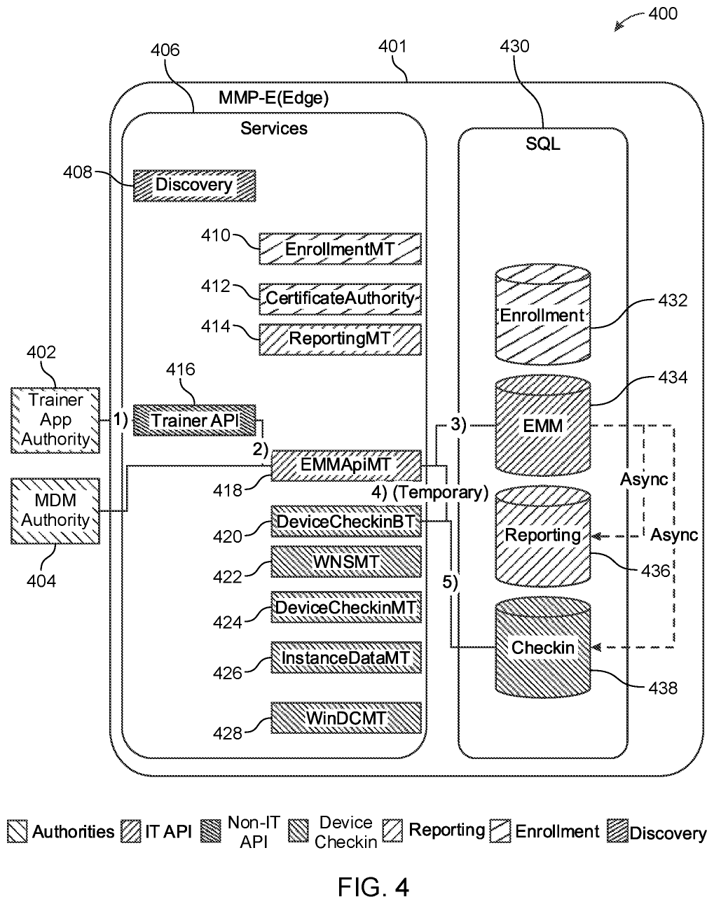

The enrollment module 401 can be enrollment module 217 illustrated in FIG. 2 and described above. In some examples, the enrollment module 401 receives instructions from a local MDM authority 404 and a non-IT authority 404. The enrollment module 401, the local MDM authority 404, and the non-IT authority 404 are described in greater detail in the description of FIG. 4 below.

In some examples, the LEAP hubs can be arranged hierarchically within the system 300. For example, the LEAP hub 330 and the LEAP hub 320 can be arranged in a parent-child relationship where the child hub is enrolled with a parent hub. As shown in FIG. 3, the LEAP hub 330 is the parent hub and the LEAP hub 320 is the child hub, but various examples are possible. In examples where a parent-child hub relationship is present within the system 300, the parent hub functions similarly to the cloud connect and acts as a higher ranked authority, for example delegating the MDM IT administrator to request devices to enroll as one or more other authorities. Accordingly, the system 300 presents an architecture where the LEAP hub 320 has its own ecosystem for enrollment, configuration of local devices 340, execution, and so forth but also maintains extensibility for higher authorities to control the LEAP hub 320, when necessary, that manages the enrolled devices 340.

For example, the LEAP hub 330 can be similar to the cloud computing device 310, but a localized hub rather than a cloud-based hub. Each is capable of calling into the EMM API that is configured to control the local device 340, but as higher authorities also are configured to set guard rails, capabilities, and/or restrictions on a lower authority in the hierarchy. As shown in FIG. 3, the LEAP hub 320 is arranged as a higher authority than the LEAP hub 330, which is arranged as a higher authority than the local device 340. Accordingly, the local device 340 only periodically returns to the LEAP hub 320 to receive instructions for configurations and so forth.

In some examples, the system 300 further provides a pluggable identity model for device and user authentication and targeting. In some examples, authentication and targeting can be certificate based for device only management. In some examples, per-user management is accomplished by an air gap version of AAD or a third-party model. Further, due to the encapsulated nature and extensibility model of the system 300, the system 300 provides a potentially isolated hub to host a device management system to integrate the device management system into a cloud-based device management system.

FIG. 4 is a block diagram illustrating an example system including edge web services and a datastore according to various examples of the present disclosure. The system 400 is but one example of a suitable system and is not intended to suggest any limitation as to the scope of use or functionality of the examples disclosed herein. Neither should the system 400 be interpreted as having any dependency or requirement relating to any one or combination of components/modules illustrated.

FIG. 4 illustrates the process of enrolling a device to a hub. As illustrated in FIG. 4, the system 400 includes an enrollment module 401. The enrollment module 401 further includes web services 406 and a structured query language (SQL) 430. The web services 406 includes one or more web services, including, but not limited to, discovery services 408, an enrollment service 410, a certificate authority 412, a reporting service 414, a trainer API 416, an EMM API 418, a device check-in BT service 420, a notification service 422, such as a Windows™ Notification System MT, a device check-in MT service 424, an instance data service 426, and a WinDCMT 428. The trainer API 416 receives instructions from an external trainer app authority 402 and the EMM API 418 receives instructions from an MDM authority 404. The received instructions can be configuration instructions as described herein. In some examples, the system 400 is implemented on a device or devices as described herein, for example the computing device 100, the platform management server 202, the LEAP hub 320, the LEAP hub 330, the LEAP hub 520, the LEAP hub 620, and/or the LEAP hub 720.

The SQL 430 is a datastore that communicates with a database. The SQL 430 includes an enrollment module 432, an EMM module 434, a reporting module 436, and a check-in module 438. The EMM module 434 communicates with the EMM API 418 and places an async call to one or both of the reporting module 436 and the check-in module 438. The device check-in BT 420 further communicates with the check-in module 438.

As described herein, the device, or devices, in the system 400 use a discovery uniform resource identifier (URI) to retrieve the needed URIs. The device utilizes the enrollment URIs following an implementation of an OMA device management (DM) protocol to negotiate capabilities with a hub, such as the MMP edge hub described herein, allowing the hub to allocate and/or provision the enrollment device certificate. The enrollment device certificate secures the device to hub communication link through SSL during the device check-in.

Accordingly, the device is enabled to securely communicate with the hub following the OMA DM protocol in order to receive the latest device actions, instructions, and configurations such as reboot, policies, and so forth during a device check-in. A device check-in is where a periodic ping from the device to the hub is executed. In some examples, the device periodically pings the hub by utilizing schedule tasks where the frequency of the ping is dictated by the hub. In other examples, the hub pings the device to begin a check-in by utilizing the notification service 422.

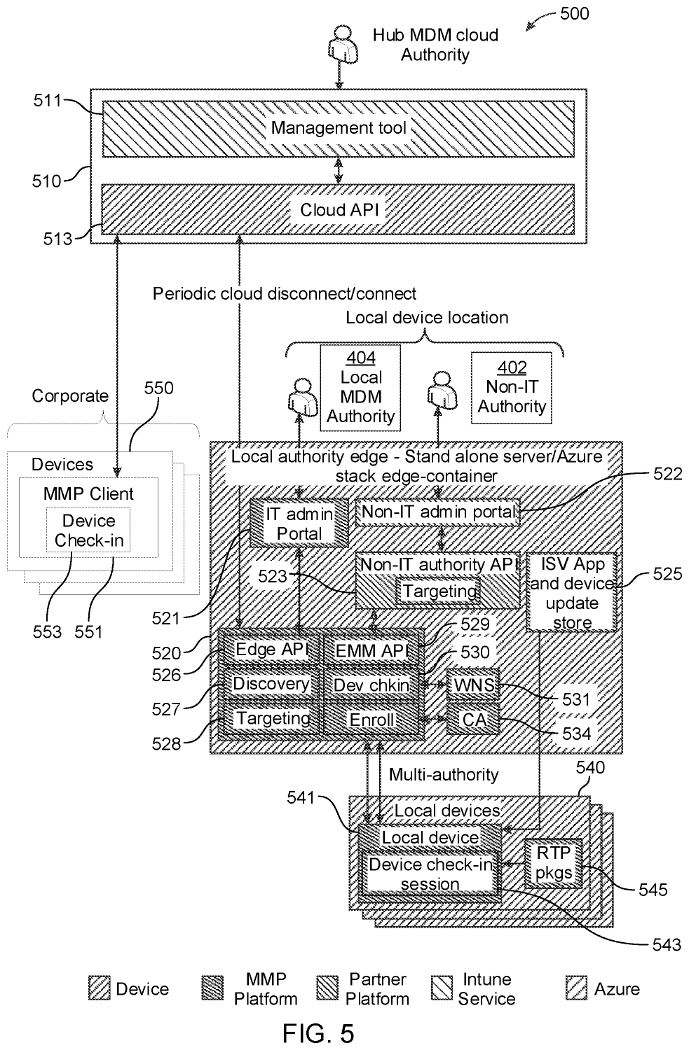

FIG. 5 is a block diagram illustrating an example system including a multi-authority hub according to various examples of the present disclosure. The system 500 is but one example of a suitable system and is not intended to suggest any limitation as to the scope of use or functionality of the examples disclosed herein. Neither should the system 500 be interpreted as having any dependency or requirement relating to any one or combination of components/modules illustrated.

The system 500 illustrated in FIG. 5 illustrates a multi-authority edge hub. In other words, the hub receives configuration instructions from multiple authorities, such as an MDM authority and a trainer authority. For examples, the system 500 enables the management of devices from physical locations for IT purposes and for non-IT purposes rather than the from a cloud device, given the need for response and control. In some examples, a non-IT purpose includes a control plane to orchestrate a trainer/teacher scenario, a control plane for technician troubleshooting, and so forth. The system 500 illustrates a multi-authority edge platform that enables multiple authorities to configure a local device, an on-premises device, and so forth. In some examples, the RBAC, policies, identity, inventory, auditing, and so forth can be controlled by a cloud authority, such as the cloud device 510, when the LEAP hub 520 connects to the cloud.

The system 500 includes a cloud computing device 510. In some examples, the cloud computing device 510 is an IT administrator, or IT administrators, that implements a cloud computing device or devices. In some examples, the cloud computing device 510 is referred to herein as a first configuration authority and/or a hub MDM cloud authority. The cloud computing device 510 includes a management tool 511 and a cloud API 513. In some examples, the cloud API 513 is an EMM API. In some examples, the cloud computing device 510 is the cloud computing device 310.

The system 500 further includes a local edge authority platform (LEAP) hub 520. In some examples, the LEAP hub 520 is the computing device 101, the platform management server 202, and/or the LEAP hub 320. For example, the LEAP hub 520 can be a local server or any other suitable computing device. The LEAP hub 520 includes an IT administrative portal 521 that transmits and receives signals to and from, respectively, a local MDM authority. The LEAP hub 520 further includes a non-IT administrative portal 522 and a non-IT authority API 523. The non-IT administrative portal 522 transmits and receives signals to and from, respectively, a local device trainer authority and the non-IT authority API 523.

The LEAP hub 520 further includes an edge API 526 that includes a discovery module 527 that discovers devices, a targeting module 528 that targets a discovered device, an EMM API 529 that communicates with the non-IT authority API 523, a device check-in module 530 that checks in the targeted device using a notification service 531, for example the Windows™ Notification Service, and an enrollment module 532 that enrolls the checked-in device via the CA 534. The LEAP hub 520 further includes an ISV application and device update store 525 that enables the downloading and installing of updates for a local device 540.

The system 500 further includes at least one local device 540. In some examples, the at least one local device 540 is the managed device 204. Although illustrated in FIG. 5 as including one local device 540, the local device 540 is illustrated for simplicity only. The system 500 can include any number of local devices 540 without departing from the scope of the present disclosure. Each local device 540 includes an MMP client 541 that is updated via the ISV application and device update store 525 and enrolled via the enrollment module 532. The local device 540 includes a clearly segregated privilege surface area to enable the segregated configuration as described herein. A device check-in session 543 is selectively and periodically executed in order to check-in with one or more authorities with which the local device 540 is enrolled to be configured by. The local device 540 further includes one or more real-time transport (RTP) packets 545 that deliver data to the MMP client 541.

In some examples, the system 500 further includes a corporate device 550. The corporate device 550 can be similar to the local device 540, for example including similar features such as an MMP client 551 and a device check-in module 553. In some examples, the corporate client 550 is managed solely from the cloud computing device 510 and is not integrated with the LEAP hub 520. Accordingly, various examples of the present disclosure recognize and take into account that an IT administrator, such as the cloud device 510, can be integrated with a LEAP hub, such as the LEAP hub 520, that is integrated with multiple authorities while simultaneously controlling other devices outside the hierarchy that does not have a need for specialization, does not have a need to handle cloud disconnect, and has its own identity solution.

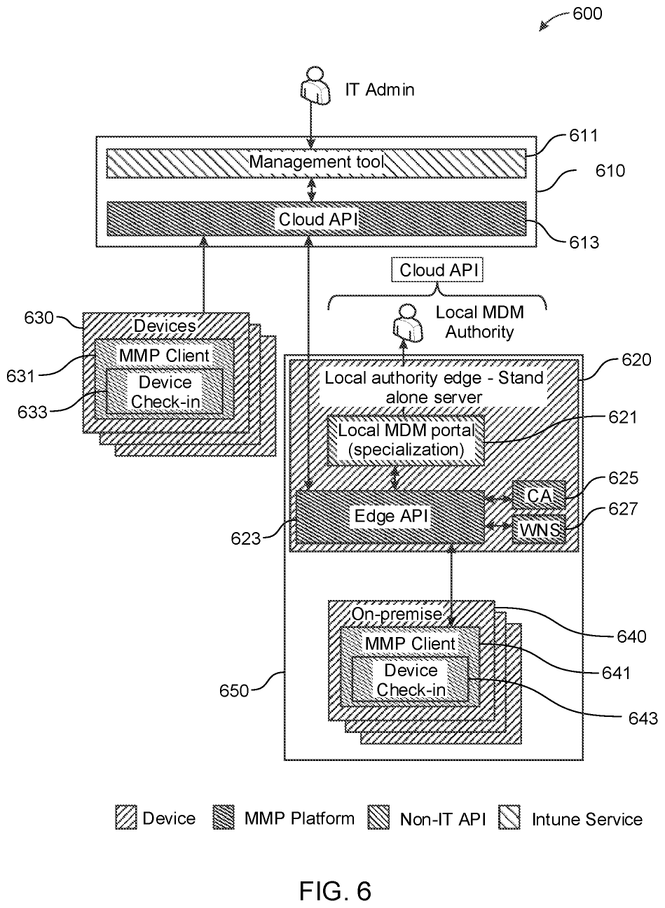

FIG. 6 is a block diagram illustrating an example system including a configuration filter hub according to various examples of the present disclosure. The system 600 is but one example of a suitable system and is not intended to suggest any limitation as to the scope of use or functionality of the examples disclosed herein. Neither should the system 600 be interpreted as having any dependency or requirement relating to any one or combination of components/modules illustrated.

The system 600 illustrated in FIG. 6 illustrates a configuration filter edge hub. The configuration filter edge hub enables devices to be gated from an enterprise IT, allowing a local edge authority to inspect and reject, approve, and/or modify a proposed IT change. Allowing a local edge authority to inspect a proposed IT change enables the intended integrity of the devices behind the gate to be maintained. Accordingly, the configuration filter edge hub illustrated in the system 600 detects a higher authority, proposes changes if determined to be necessary, and alerts a local authority to the changes that are to be processed. For example, an enterprise that utilizes a system center configuration manager (SCCM) for on-premise local authority control and a cloud-based enterprise-wide device management via the cloud could determine to avoid the infrastructure and logistics that come with supporting SCCM and using the Internet's infrastructure offered by the cloud-based enterprise-wide device management.

The system 600 includes a cloud computing device 610. In some examples, the cloud computing device 610 is an IT administrator, or IT administrators, that implements a cloud computing device or devices. In some examples, the cloud computing device 610 is referred to herein as a first configuration authority and/or a hub MDM cloud authority. The cloud computing device 610 includes a management tool 611 and a cloud API 613. The cloud computing device 610 receives instructions from an IT administrator, or user, for configuring a local device, such as the local device 630 and/or the on-premises device 640. In some examples, the cloud API 613 is an EMM API.

The system 600 further includes a local edge authority platform (LEAP) hub 620. In some examples, the LEAP hub 620 is the computing device 101, the platform management server 202, the LEAP hub 320, the LEAP hub 330, and/or the LEAP hub 520. For example, the LEAP hub 520 can be a local server or any other suitable computing device. The LEAP hub 620 includes a local MDM portal 621 that transmits signals to a local MDM authority and transmits signals to and from an edge API 623 of the LEAP hub 620. The edge API 623 performs various functions as described herein, for example checking in a local device using a notification service 627, for example the Windows™ Notification Service, and enrolling the checked-in device via the CA 625.

The system 600 further includes at least one local device 630 and at least one on-premise device 640. In some examples, the at least one local device 630 and/or 640 is the managed device 204. The at least one local device 630 includes an MMP client 631 and a device check-in module 633. Similarly, the at least one on-premise device 640 includes an MMP client 641 and a device check-in module 643. In some examples, the on-premise device 640 is a local authority that is authorized to configure at least part of the local device 630. For example, the cloud computing device 610 can be a first configuration authority and the on-premises device 640 can be a second configuration authority. The process of configuring the local device 630 based configuration instructions received from each of the first configuration authority and the second configuration authority is described in greater detail below.

The system 600 further includes a security isolation boundary 650 that isolates the LEAP hub 620 and the on-premises device 640 from the local device 630 that is not controlled by the LEAP hub 620. In other words, the security isolation boundary 650 is a subnet providing a single access point to the LEAP hub 620 such that the LEAP hub 620 manages only the devices inside the security isolation boundary 650.

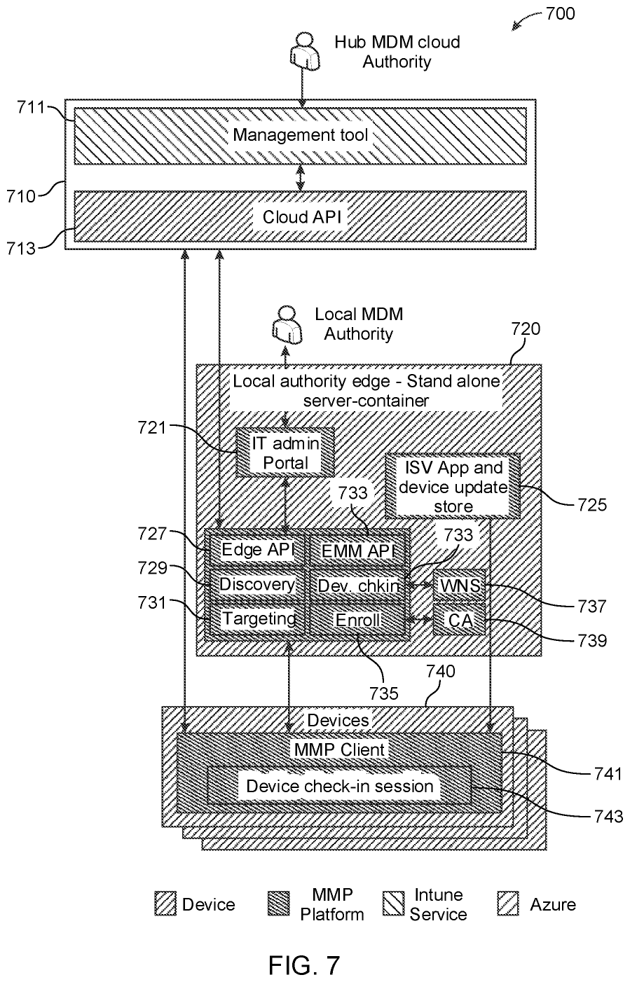

FIG. 7 is a block diagram illustrating an example system implementing the local edge authority platform according to various examples of the present disclosure. The system 700 is but one example of a suitable system and is not intended to suggest any limitation as to the scope of use or functionality of the examples disclosed herein. Neither should the system 700 be interpreted as having any dependency or requirement relating to any one or combination of components/modules illustrated.

The system 700 includes a cloud computing device 310. In some examples, the cloud computing device 310 is an IT administrator, or IT administrators, that implements a cloud computing device or devices. In some examples, the cloud computing device 710 is referred to herein as a first configuration authority and/or a hub MDM cloud authority. As shown in FIG. 7, the cloud computing environment 710 includes a management tool 711 and a cloud API 713. In some examples, the cloud API 713 is an EMM API.

The system 700 further includes a local edge authority platform (LEAP) hub 720. In some examples, the LEAP hub 720 is the computing device 101, the platform management server 202, the LEAP hub 320, the LEAP hub 330, the LEAP hub 520, and/or the LEAP hub 620. For example, the LEAP hub 720 can be a local server or any other suitable computing device. The LEAP hub 720 includes an IT administrative portal 721 that transmits and receives signals to and from, respectively, a local MDM authority. The LEAP hub 720 further includes an ISV application and device update store 725 that enables the downloading and installing of updates for the at least one local device 740.

The LEAP hub 720 further includes an edge API 727 that includes a discovery module 729 that discovers devices, a targeting module 731 that targets a discovered device, an EMM API 733, a device check-in module 734 that checks in the targeted device using a notification service 737, for example the Windows™ Notification Service, and an enrollment module 735 that enrolls the checked-in device via the CA 739.

The system 700 further includes the at least one local device 740. In some examples, the at least one local device 740 is the managed device 204. Although illustrated in FIG. 7 as including one local device 740, the local device 740 is illustrated for simplicity only. The system 700 can include any number of local devices 740 without departing from the scope of the present disclosure. Each local device 740 includes an MMP client 741 that is updated via the ISV application and device update store 725 and enrolled via the enrollment module 735. The local device 740 includes a clearly segregated privilege surface area to enable the segregated configuration as described herein. A device check-in session 743 is selectively and periodically executed in order to check-in with one or more authorities with which the local device 740 is enrolled to be configured by.

The system 700 illustrates a break glass scenario. A glass break scenario is a scenario where the hub software takes over from the cloud to continue management until an issue is resolved. Examples of break glass scenarios can include, but are not limited to, an outage in the cloud where the cloud computing device 710 is unavailable to send configuration and/or management instructions. For example, where the local device 740 is experiencing difficulty connecting to the local MDM authority, the LEAP hub 720 can be turnkey installed onto a server device from a cloud computing environment 710, the resource manager 715, and/or locally from the local device 740. Following the installation of the LEAP hub 720, an IT administrator can deploy an update or otherwise fix the issue in order for the local device 740 to reconnect to the local MDM authority. Accordingly, the system 700 illustrates a hybrid management model, or a hybrid control plane, of local devices to provide multiple points of authority in the event that one authority is unavailable. The hybrid management model provides a mixture of cloud- and local-authority to manage devices as necessary.

Furthermore, a local device 740 that is enrolled into the LEAP hub 720 enables the local device 740 to be utilized as a local tool in various examples. In one example, the local device 740 is used throughout the development lifecycle of a next generation of security features managed by the MDM as a test device. In another example, the local device 740 can be used as both a package generator and a verification tool of the next generation of a configuration designer, such as the Windows™ Configuration Designer (WCD). In yet another example, the local device 740 can be placed into an investigative mode by an IT administrator even after the local device 740 has been shipped and put into use. In this example, the investigative mode can be used for troubleshooting, exercising potential new applications or features, and so forth. When the local device 740 exits the investigative mode, the local device 740 can remove and/or revert actions taken by the investigator and revert back to the original state.

In some examples, the local device 740 enrolled into the LEAP hub 720 further is enabled to be utilized as an enterprise evaluation tool in order to enable and exercise various features offered by a software provider. For example, the local device 740 is enabled to provide a feature demonstration and/or evaluation due to its enrollment into the LEAP hub 720.

It should be understood that although the system 300, the system 400, the system 500, the system 600, and the system 700 are described as separate systems, this should not be construed as limiting. Various examples of the systems 300-700 are possible and elements from one system can be included in another system as illustrated in FIGS. 3-7. For example, the parent-child relationship of the LEAP hub 330, the LEAP hub 320, and the at least one local device 340 illustrated in FIG. 3 can be implemented in any of the systems 400-700 illustrated in FIGS. 4-7, respectively.

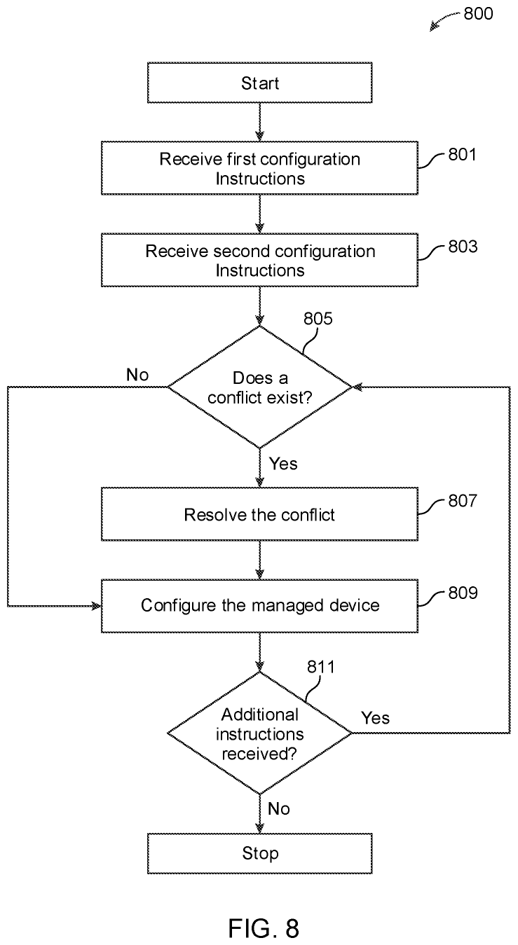

FIG. 8 is a flow chart diagram illustrating operations of a computer-implemented method for configuring a managed device 204 according to various examples of the present disclosure. The operations illustrated in FIG. 8 are for illustration and should not be construed as limiting. Various examples of the operations can be used without departing from the scope of the present disclosure. The operations of the flow chart 800 can be executed by a local edge authority platform, for example any one of the computing device 100, the platform management server 202, the LEAP hub 320, the LEAP hub 330, the LEAP hub 520, the LEAP hub 620, and/or the LEAP hub 720.

Various examples of the present disclosure recognize and take into account the potential for a LEAP hub, such as any one of the LEAP hub 320, the LEAP hub 520, the LEAP hub 620, and the LEAP hub 720, to receive conflicting configuration instructions for one or more local devices, i.e., managed devices, in examples where more than one configuration authority is included in a respective system. Accordingly, various examples of the present disclosure include a hierarchy of configuration authorities that a LEAP hub can use to prioritize respective configuration instructions for a local device, i.e., a managed device. In these examples, the configuration instructions from a highest ranked configuration authority are prioritized and implemented to configure the managed device. Configuration instructions from a lower ranked configuration authority are analyzed to determine which of the instructions conflict with the instructions received from the higher ranked configuration authority. The LEAP hub then continues to configure the managed device by implementing the instructions from the lower ranked configuration authority that do not conflict with the instructions from the higher ranked configuration authority while opting not to implement the conflicting instructions. The process by which a LEAP hub resolves a conflict of received configuration instructions is described in greater detail below.

The flow chart 800 begins by the platform management server 202 receiving first configuration instructions in operation 801. The first configuration instructions are received from a first configuration authority, such as an administrator. In some examples, the first configuration authority is the administrator 206. The first configuration instructions include instructions for configuring a managed device, such as the managed device 204. In some examples, the first configuration instructions are received in a configuration packet received from the first configuration authority. In some examples, the configuration packet includes, but is not limited to, configuration settings and the data that may be necessary to achieve a device state that is defined by the configuration settings.

In operation 803, the platform management server 202 receives second configuration instructions. The second configuration instructions are received from a second configuration authority, such as one or more of the enterprise services 208. The second configuration instructions include instructions for configuring the managed device 204. In some examples, the second configuration instructions are received in a configuration packet received from the second configuration authority. As described above, the configuration packet includes, but is not limited to, configuration data and the data that may be necessary to achieve a device state that is defined by the configuration settings.

It should be appreciated that although the flow chart 800 illustrates receiving configuration instructions from the first configuration authority and the second configuration authority, various examples are possible. For example, instructions can be received from more than two configuration authorities or less than two configuration authorities without departing from the scope of the present disclosure.

In some examples, the platform management server 202 segregates the received first configuration instructions from the received second configuration instructions. In some examples, each individual configuration authority has a segregated privilege surface area that defines a dedicated portion, or portions, of the managed device 204 that each particular configuration authority is authorized to configure. The particular, dedicated portions are segregated such that first configuration instructions received from the first configuration authority are not implemented in a portion of the managed device 204 that the first configuration authority is not authorized to configure. However, in some examples not all portions of the managed device 204 can be segregated. For example, the first configuration authority and the second configuration authority can be authorized to configure different aspects of the managed device 204, but both aspects include implementations on a user interface. In this example, complete segregation is not feasible because the user interface is used for each implementation. Therefore, it should be understood that a conflict can exist, in some examples, even when segregation of the first configuration instructions and the second configuration instructions is successfully implemented.

In operation 805, the platform management server 202 determines whether a conflict exists. In some examples, the second configuration instructions are compatible with the first configuration instructions. In other words, the second configuration instructions do not include instructions for configuring the managed device 204 that conflict with the first configuration instructions. When the platform management server 202 determines there is not a conflict between the first configuration instructions and the second configuration instructions, the flow chart 800 proceeds to operation 809. In other examples, the second configuration instructions conflict with the first configuration instructions. In other words, the second configuration instructions include at least some instructions for configuring the managed device 204 that conflict with at least a portion of the first configuration instructions. When the platform management server 202 determines there is a conflict between the first configuration instructions and the second configuration instructions, the flow chart 800 proceeds to operation 807.

In some examples, determining whether a conflict exists includes examining the particular instructions included in the respective configuration packets received from the first configuration authority and the second configuration authority. A conflict is identified when implementing the configuration settings or data received in one configuration packet would inhibit the configuration settings or data received in another configuration packet from being implemented. For example, the platform management server 202 determines a conflict exists when the first configuration instructions include instructions to display a particular type of data on a user interface and the second configuration instructions include instructions not to display a particular type of data on the user interface.

In some examples, a conflict is determined to exist where each of the first configuration authority and the second configuration authority are authorized to configure an overlapping portion of the managed device 204.

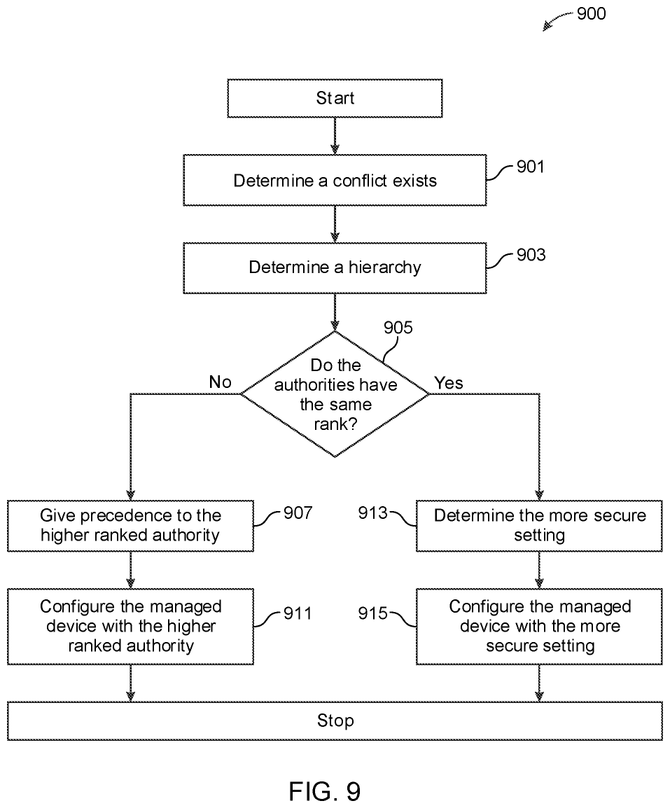

In operation 807, based on the determining a conflict exists in operation 805, the platform management server 202 resolves the determined conflict. The platform management server 202 determines a hierarchy of configuration authorities that includes the first configuration authority and the second configuration authority. In some examples, the platform management server 202 identifies the first configuration authority and the second configuration authority within a pre-existing local edge authority framework. The highest ranked authority within the local edge authority framework is then given precedence. Accordingly, the configuration instructions from the higher ranked authority of the first configuration authority and the second configuration authority is given precedence. Resolving the conflict is described in greater detail below in the description of FIG. 9.

In operation 809, the platform management server 202 configures the managed device 204. The platform management server 202 configures the managed device 204 by implementing the configuration instructions of the highest ranked authority of the first configuration authority and the second configuration authority and the non-conflicting configuration instructions of the lower ranked authority of the first configuration authority and the second configuration authority.

In operation 811, the platform management server 202 determines whether additional instructions are received. The platform management server 202 can receive additional instructions from one or more of the first configuration authority, the second configuration authority, and an additional configuration authority. If additional instructions are not received, the flow chart 800 terminates. If additional instructions are received, the platform management server 202 proceeds to operation 805 and determines whether a conflict exists between any of the previously received configuration instructions and the additionally received instructions.

In one example, the platform management server 202 determines a second conflict exists between the additionally received configuration instructions and at least one of the first configuration instructions or the second configuration instructions in the same manner that the first conflict was determined in operation 805. The platform management server 202 then resolves the second conflict in the same manner the first conflict was resolved in operation 807 and re-configures the managed device 204 in the same manner the managed device 204 was originally configured in operation 809. The operations of the flow chart 800 are performed as described herein until additional instructions are not received in operation 811 and the flow chart 800 terminates.

FIG. 9 is a flow chart diagram illustrating operations of a computer-implemented method for resolving a conflict between configuration instructions according to various examples of the present disclosure. The operations illustrated in FIG. 9 are for illustration and should not be construed as limiting. Various examples of the operations can be used without departing from the scope of the present disclosure. The operations of the flow chart 900 can be executed by a local edge authority platform, for example any one of the computing device 100, the platform management server 202, the LEAP hub 320, the LEAP hub 330, the LEAP hub 520, the LEAP hub 620, and/or the LEAP hub 720.

As described herein, the flow chart 900 illustrates operations of determining a conflict exists, resolving the conflict, and configuring the managed device as described in operations 805-809 above. In operation 901, the platform management server 202 determines a conflict exists. For example, the platform management server 202 determines implementing the configuration settings or data received in the first configuration instructions would inhibit the configuration settings or data received in the second configuration instructions from being implemented, or vice versa.

In operation 903, based on determining a conflict exists, the platform management server 202 determines a hierarchy that includes at least the first configuration authority and the second configuration authority. In some examples, determining the hierarchy includes ranking the first configuration authority and the second configuration authority. In some examples, determining the hierarchy includes accessing a pre-existing local edge authority framework and identifying each of the first configuration authority and the second configuration authority within the local edge authority framework. For example, the local edge authority framework can include a hierarchy of configuration authorities from which the platform management server 202 can receive configuration instructions. The platform management server 202 identifies the first configuration authority and the second configuration authority within the local edge authority framework to determine a ranking of the first configuration authority and the second configuration authority.

In some examples, the local edge authority framework includes a linear listing of configuration authorities from a highest rank to a lowest rank. In this example, the local edge authority framework does not include configuration authorities that include a same rank within the hierarchy. In other examples, the local edge authority framework includes one or more tiers of configuration authorities. The tiers group different configuration authorities together to provide a hierarchy of configuration authorities. In this example, a first tier includes one or more configuration authorities and a second tier includes one or more configuration authorities. Each of the configuration authorities included in the first tier are ranked higher than each configuration authority in the second tier. In some examples, a tier can include sub-tiers that rank the configuration authorities in the tier. For example, the second tier can include a first sub-tier ranked higher than a second sub-tier such that a configuration authority is the first sub-tier is ranked lower than each configuration authority in the first tier, but higher than each configuration authority in the second sub-tier of the second tier.

In operation 905, the platform management server 202 determines whether the first configuration authority and the second configuration authority have the same rank within the local edge authority framework. For example, the platform management server 202 identifies first configuration authority and the second configuration authority within the local edge hierarchy framework. In examples where the local edge hierarchy framework is organized into tiers, the tier and, when applicable, the sub-tier, of both the first configuration authority and the second configuration authority are identified. In some examples, the first configuration authority and the second configuration authority are organized, or sorted, into the same tier. In some examples, the first configuration authority and the second configuration authority are organized, or sorted, into the same sub-tier within the same tier. In examples where the first configuration authority and the second configuration authority are not determined to have the same rank, the flow chart 900 proceeds to operation 907. In examples where the first configuration authority and the second configuration authority are determined to have the same rank, the flow chart 900 proceeds to operation 913.

In operation 907, based on determining the first configuration authority and the second configuration authority do not have the same rank within the local edge hierarchy framework, the platform management server 202 prioritizes the configuration instructions received from the higher ranked configuration authority. In other words, where the first configuration authority is ranked higher than the second configuration authority, the first configuration instructions are prioritized over the second configuration instructions. Where the second configuration authority is ranked higher than the first configuration authority, the second configuration instructions are prioritized over the first configuration instructions.

In operation 911, the platform management server 202 configures the managed device 204, giving priority to the configuration instructions from the identified higher ranked configuration authority. For example, the platform management server 202 configures the managed device 204 by implementing the configuration instructions of the highest ranked authority of the first configuration authority and the second configuration authority and the non-conflicting configuration instructions of the lower ranked authority of the first configuration authority and the second configuration authority.

In operation 913, based on determining the first configuration authority and the second configuration authority have the same rank within the local edge hierarchy framework, the platform management server 202 determines which of the first configuration instructions and the second configuration instructions provide a more secure setting. In some examples, some configuration instructions require additional security protocols not included in other configuration instructions. Accordingly, the configuration instructions that require additional security protocols are prioritized over the configuration instructions that do not require the additional security protocols. In some examples, the conflict can be resolved by prioritizing first received instructions over later instructions where the authorities from which the conflicting instructions were received are equal in the hierarchy.

In operation 915, the platform management server 202 configures the managed device 204, giving priority to the configuration instructions that were identified as more secure in operation 913. For example, the platform management server 202 configures the managed device 204 by implementing the more secure configuration instructions.

FIG. 10 is a block diagram illustrating an example cloud infrastructure according to various examples of the present disclosure. The cloud-computing environment 1000 includes a public network 1002, a private network 1004, and a dedicated network 1006. The public network 1002 may be a public cloud-based network of computing resources, for example. The private network 1004 may be a private enterprise network or private cloud-based network of computing resources. The dedicated network 1006 may be a third-party network or dedicated cloud-based network of computing resources. The hybrid cloud 1008 may include any combination of public network 1002, private network 1004, and dedicated network 1006.

The public network 1002 may include data centers configured to host and support operations, including tasks of a distributed application, according to the fabric controller 1018. It will be understood and appreciated that data center 1014 and data center 1016 shown in FIG. 10 are merely examples of suitable implementations for accommodating one or more distributed applications and are not intended to suggest any limitation as to the scope of use or functionality of examples disclosed herein. Neither should data center 1014 and data center 1016 be interpreted as having any dependency or requirement related to any single resource, combination of resources, combination of servers (e.g., servers 1020 and 1024) combination of nodes (e.g., nodes 1032 and 1034), or a set of application programming interfaces (APIs) to access the resources, servers, and/or nodes.

The data center 1014 illustrates a data center comprising a plurality of servers, such as servers 1020 and 1024. A fabric controller 1018 is responsible for automatically managing the servers 1020 and 1024 and distributing tasks and other resources within the data center 1014. By way of example, the fabric controller 1018 may rely on a service model (e.g., designed by a customer that owns the distributed application) to provide guidance on how, where, and when to configure server 1022 and how, where, and when to place application 1026 and application 1028 thereon. One or more role instances of a distributed application may be placed on one or more of the servers 1020 and 1024 of data center 1014, where the one or more role instances may represent the portions of software, component programs, or instances of roles that participate in the distributed application. In other examples, one or more of the role instances may represent stored data that are accessible to the distributed application.

The data center 1016 illustrates a data center comprising a plurality of nodes, such as node 1032 and node 1034. One or more virtual machines may run on nodes of data center 1016, such as virtual machine 1036 of node 1034 for example. Although FIG. 10 depicts a single virtual node on a single node of data center 1016, any number of virtual nodes may be implemented on any number of nodes of the data center in accordance with illustrative embodiments of the disclosure. Generally, virtual machine 1036 is allocated to role instances of a distributed application, or service application, based on demands (e.g., amount of processing load) placed on the distributed application. As used herein, the phrase “virtual machine,” or VM, is not meant to be limiting, and may refer to any software, application, operating system, or program that is executed by a processing unit to underlie the functionality of the role instances allocated thereto. Further, the VMs 1036 may include processing capacity, storage locations, and other assets within the data center 1016 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 1030 is responsible for automatically managing the virtual machines running on the nodes of data center 1016 and for placing the role instances and other resources (e.g., software components) within the data center v16. By way of example, the fabric controller 1030 may rely on a service model (e.g., designed by a customer that owns the service application) to provide guidance on how, where, and when to configure the virtual machines, such as VM 1036, and how, where, and when to place the role instances thereon.

As described above, the virtual machines may be dynamically established and configured within one or more nodes of a data center. As illustrated herein, node 1032 and node 1034 may be any form of computing devices, such as, for example, a personal computer, a desktop computer, a laptop computer, a mobile device, a consumer electronic device, a server, and like. VMs machine(s) 1036, while simultaneously hosting other virtual machines carved out for supporting other tenants of the data center 1016, such as internal services 1038, hosted services 1040, and storage 1042. Often, the role instances may include endpoints of distinct service applications owned by different customers.

In some embodiments, the hosted services 1040 include a LEAP hub 320 configured to perform the various features discussed herein. Although illustrated in FIG. 10 as a LEAP hub 320, it should be understood that the LEAP hub 320 illustrated in FIG. 10 can be any one of the platform management server 202, the LEAP hub 320, the LEAP hub 330, the LEAP hub 520, the LEAP hub 620, and/or the LEAP hub 720 described herein.

### Additional Examples

Some examples herein are directed to a method of configuring a managed device, as illustrated by the flow chart 800. The method (800) includes receiving (801) first configuration instructions from a first configuration authority for configuring a managed device; receiving (803) second configuration instructions from a second configuration authority for configuring the managed device, wherein the first configuration authority is different than the second configuration authority; determining (805) a conflict exists between the first configuration instructions and the second configuration instructions; resolving (807) the conflict; and configuring (809) the managed device based on the resolved conflict.

In some examples, the first configuration authority (310, 510, 610, 710) is an administrator.

In some examples, the method further includes determining the conflict exists includes determining at least a part of the first configuration instructions conflict with at least a part of the second configuration instructions.

In some examples, the method further includes determining a hierarchy that includes the first configuration authority (310, 510, 610, 710) and the second configuration authority (330).

In some examples, the method further includes prioritizing configuration instructions received from a highest ranked authority, of the first configuration authority (310, 510, 610, 710) and the second configuration authority (330), in the hierarchy.

In some examples, the method further includes determining the first configuration authority (310, 510, 610, 710) and the second configuration authority (330) include the same ranking within the hierarchy; determining which of the first configuration authority (310, 510, 610, 710) and the second configuration authority (330) includes a more secure setting; and configuring the managed device (204) with the determined more secure setting.

In some examples, the method further includes receiving additional configuration instructions from at least one of the first configuration authority (310, 510, 610, 710) or the second configuration authority (330); determining a second conflict exists between the additional configuration instructions and at least one of the first configuration instructions (310, 510, 610, 710) or the second configuration instructions (330); resolving the second conflict; and reconfiguring the managed device (204) based on the resolved second conflict.

In some examples, at least one of the first configuration authority (310, 510, 610, 710) or the second configuration (330) is a parent hub device. Configuring the managed device (204) can include configuring a child hub device.

Although described in connection with an example computing device 100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

1. A computer-implemented method, the method comprising:
receiving first configuration instructions from a first configuration authority for configuring a managed device;
receiving second configuration instructions from a second configuration authority for configuring the managed device, wherein the first configuration authority is different than the second configuration authority;
determining a conflict exists between the first configuration instructions and the second configuration instructions;
determining correct configurations instruction for resolving the conflict; and
in response to receiving the check-in, configuring the managed device based on the correct configuration instructions.

2. The computer-implemented method of claim 1, wherein the first configuration authority is an administrator.

3. The computer-implemented method of claim 1, wherein determining the conflict exists includes determining at least a part of the first configuration instructions conflict with at least a part of the second configuration instructions.

4. The computer-implemented method of claim 1, further comprising determining a hierarchy that includes the first configuration authority and the second configuration authority.

5. The computer-implemented method of claim 4, wherein resolving the conflict includes prioritizing configuration instructions received from a highest ranked authority, of the first configuration authority and the second configuration authority, in the hierarchy.

6. The computer-implemented method of claim 4, further comprising:
determining the first configuration authority and the second configuration authority include the same ranking within the hierarchy;
selecting between the first configuration authority and the second configuration authority based on security; and
configuring the managed device with the selected one of the first configuration authority and the second configuration authority.

7. The computer-implemented method of claim 1, further comprising;
receiving additional configuration instructions from at least one of the first configuration authority or the second configuration authority;
determining a second conflict exists between the additional configuration instructions and at least one of the first configuration instructions or the second configuration instructions;
resolving the second conflict; and
reconfiguring the managed device based on the resolved second conflict.

8. The computer-implemented method of claim 1, wherein:
at least one of the first configuration authority or the second configuration is a parent hub device, and
configuring the managed device includes configuring a child hub device.

9. One or more servers, each of the one or more servers comprising:
a processor; and
a computer-readable medium storing instructions that, when executed by the processor, cause the processor to:
receive first configuration instructions from a first configuration authority for configuring a managed device;
receive second configuration instructions from a second configuration authority for configuring the managed device, wherein the first configuration authority is different than the second configuration authority;
determine a conflict exists between the first configuration instructions and the second configuration instructions;
determine a hierarchy that includes the first configuration authority and the second configuration authority;
determining correct configuration instructions by resolving the conflict based at least in part on the determined hierarchy;
receiving, at a hub that manages configuration policies, a check in from the managed device; and
in response to receiving the check-in, configure the managed device based on the correct configuration instructions.

10. The one or more servers of claim 9, wherein the first configuration authority is an administrator.

11. The one or more servers of claim 9, wherein the computer-readable medium further stores instructions to determine the conflict exists that, when executed by the processor, cause the processor to:
determine at least a part of the first configuration instructions conflict with at least a part of the second configuration instructions.

12. The one or more servers of claim 9, wherein the computer-readable medium further stores instructions to resolve the conflict that, when executed by the processor, cause the processor to:
prioritize configuration instructions received from a highest ranked authority, of the first configuration authority and the second configuration authority, in the hierarchy.

13. The one or more servers of claim 9, wherein the computer-readable medium further stores instructions that, when executed by the processor, cause the processor to:
determine the first configuration authority and the second configuration authority include the same ranking within the hierarchy,
selecting between the first configuration authority and the second configuration authority based on security, and
configure the managed device with the selected one of the first configuration authority and the second configuration authority.

14. The one or more servers of claim 9, wherein the computer-readable medium further stores instructions that, when executed by the processor, cause the processor to:
receive additional configuration instructions from at least one of the first configuration authority or the second configuration authority,
determine a second conflict exists between the additional configuration instructions and at least one of the first configuration instructions or the second configuration instructions,
resolve the second conflict, and
reconfigure the managed device based on the resolved second conflict.

15. The one or more servers of claim 9, wherein the computer-readable medium further stores instructions that, when executed by the processor, cause the processor to:
segregate the received first configuration instructions from the received second configuration instructions.

16. One or more computer-storage memory devices embodied with executable operations that, when executed by a processor, cause the processor to:
establish an edge authority framework including a managed device, a first configuration authority, and a second configuration authority, wherein the first configuration authority is different than the second configuration authority;
receive first configuration instructions from the first configuration authority for configuring the managed device;
receive second configuration instructions from the second configuration authority for configuring the managed device determine a conflict exists between the first configuration instructions and the second configuration instructions;
determine a hierarchy that includes the first configuration authority and the second configuration authority;
resolve the conflict based at least in part on the determined hierarchy;
waiting until the managed device checks in with a hub that manages configuration policies;
in response to receiving the check-in, configure the managed device based on the resolved conflict.

17. The one or more computer storage memory devices of claim 16, wherein the first configuration authority is an administrator.

18. The one or more computer storage memory devices of claim 16, further embodied with executable operations to determine the conflict exists that, when executed by the processor, cause the processor to:
determine at least a part of the first configuration instructions conflict with at least a part of the second configuration instructions

19. The one or more computer storage memory devices of claim 16, further embodied with executable operations that, when executed by the processor, cause the processor to:
prioritize configuration instructions received from a highest ranked authority, of the first configuration authority and the second configuration authority, in the hierarchy, and
configure the managed device based on the prioritized configuration instructions.

20. The one or more computer storage memory devices of claim 16, further embodied with executable operations that, when executed by the processor, cause the processor to:
determine the first configuration authority and the second configuration authority include the same ranking within the hierarchy,
selecting between the first configuration authority and the second configuration authority based on security, and
configure the managed device with the selected one of the first configuration authority and the second configuration authority,
selecting between the first configuration authority and the second configuration authority based on security of the two, and
configure the managed device with the selected one of the first configuration authority and the second configuration authority.
